(19) United States
(12) Patent Application Publication
(10) Pub. No.: US 2026/0236659 A1
(43) Pub. Date: Aug. 13, 2026

(54) CHIP DESIGNING METHOD, PROCESSING DEVICE OF PERFORMING CHIP DESIGNING METHOD, AND OPERATION INTERFACE OF CHIP DESIGN

(71) Applicant: SILICON MOTION INC., HSINCHU COUNTY (TW)

(72) Inventor: Chien-Hung HO, HSINCHU COUNTY (TW)

(21) Appl. No.: 19/466,542

(22) Filed: Feb. 2, 2026

(30) Foreign Application Priority Data
Feb. 13, 2025 (TW) 114105409

(51) Int. Cl. G06F 30/392

(52) U.S. Cl. CPC G06F 30/392

(57) ABSTRACT

A chip design method includes: identifying a zone surrounding the first cell; selecting a second cell, according to first peak current values of a cell group, in the cell group covered by the zone; searching accommodation spaces according to a cell area of the second cell; identify accommodation space zones, the accommodation space zones respectively surrounding the accommodation spaces; and moving the second cell to a first accommodation space in the accommodation space zones according to first summation current values of the accommodation space zones.

### CROSS - REFERENCE TO RELATED APPLICATIONS

This application claims priority to Taiwan Application Number 114105409, filed February 13, 2025, which is herein incorporated by reference.

### BACKGROUND

### Technical Field

The present disclosure relates to a chip design technique. More particularly, the present disclosure relates to a chip design method, a processing device for executing a chip design method, and an operation interface of chip design.

### Description of Related Art

In the chip design process, power voltage drop (IR-drop) is one of the key considerations. If a cell experiences excessive power voltage drop, it can lead to signal instability or errors. Therefore, after performing dynamic power voltage drop analysis, the processor identifies cells that violate the power voltage drop conditions based on the simulation results and proceeds with repairs. However, as the manufacturing process evolves and cell sizes continue to shrink, the number of cells exceeding the power voltage drop conditions increases significantly, resulting in a decrease in repair efficiency. Thus, techniques associated with solving problems described above are important issues in the field.

### SUMMARY

The present disclosure provides a chip design method. The chip design method includes: identifying a zone surrounding the first cell; selecting a second cell, according to first peak current values of a cell group, in the cell group covered by the zone; searching accommodation spaces according to a cell area of the second cell; identify accommodation space zones, the accommodation space zones respectively surrounding the accommodation spaces; and moving the second cell to a first accommodation space in the accommodation space zones according to first summation current values of the accommodation space zones.

The present disclosure provides a processing device of performing a chip designing method. The processing device includes a memory, a processor and a display. The memory is configured to store relevant data of a chip. The processor is configured to perform following operations: identifying a zone surrounding a first cell; in a cell group covered by the zone, selecting a second cell according to peak current values of the cell group; searching accommodation spaces according to a cell area of the second cell; identifying accommodation space zones, the accommodation space zones surrounding the accommodation spaces, respectively; and moving the second cell to a first accommodation space in the accommodation space zones according to first summation current values of the accommodation space zones. The display is configured to display the peak current values and the accommodation space zones.

The present disclosure provides an operation interface of chip design. The operation interface includes a design diagram of a chip. The design diagram is displayed by a display and controlled by a processor. The processor is configured to perform following operations: displaying a zone surrounding a first cell of the chip and a first summation current value of the zone; in a cell group covered by the zone, displaying a second cell being selected and a peak current value of the second cell; displaying accommodation spaces, accommodation space zones respectively surrounding the accommodation spaces and second summation current values of the accommodation space zones, wherein the second summation current values of the accommodation space zones are smaller than the first summation current value of the zone; and moving the second cell to a first accommodation space in the accommodation space zones.

It is to be understood that both the foregoing general description and the following detailed description are examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a processing device illustrated according to some embodiments of present disclosure.

FIG. 2 is a schematic diagram of a chip illustrated according to some embodiments of present disclosure.

FIG. 3 is a schematic diagram of a chip designing method illustrated according to some embodiments of present disclosure.

### DETAILED DESCRIPTION

In the present disclosure, when an element is referred to as "connected" or "coupled", it may mean "electrically connected" or "electrically coupled". "Connected" or "coupled" can also be used to indicate that two or more components operate or interact with each other. In addition, although the terms "first", "second", and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms "a", "one" and "the" are also intended to include plural forms, unless the context clearly indicates otherwise. It will be further understood that when used in this specification, the terms "comprises (comprising)" and/or "includes (including)" designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

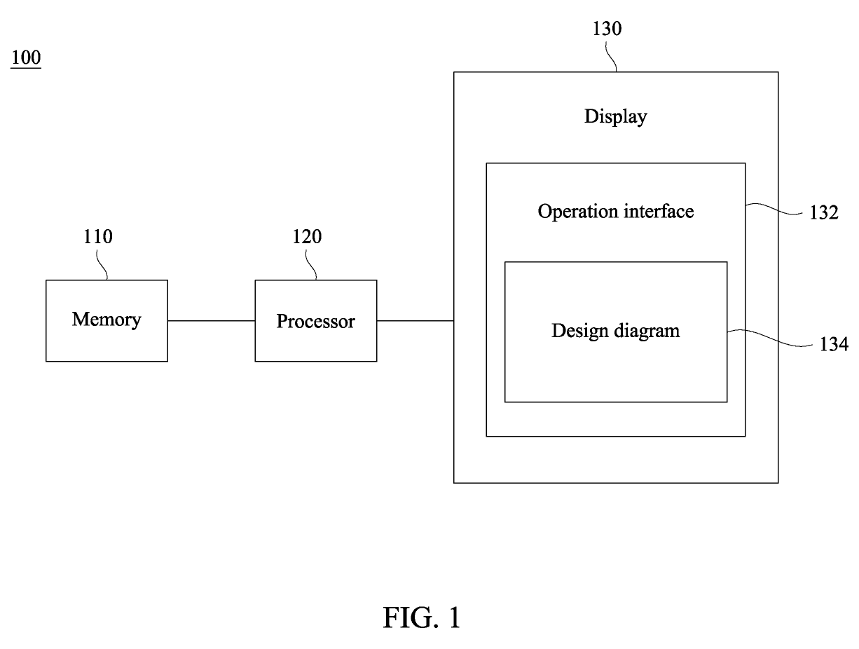

FIG. 1 is a schematic diagram of a processing device 100 illustrated according to some embodiments of present disclosure. As shown in FIG. 1, the processing device 100 includes a memory 110, a processor 120 and a display 130. The memory 110, the processor 120 and the display 130 are configured to perform chip designing, and are coupled to each other to transmit relevant data of chip designing.

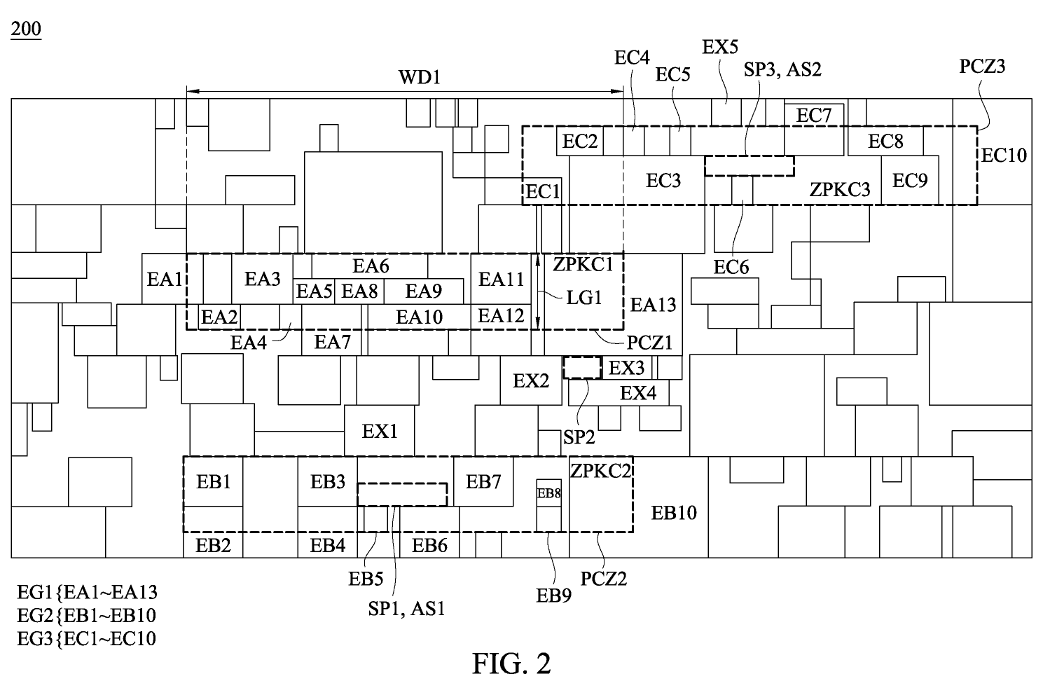

In some embodiments, the display 130 is configured to display an operation interface 132. The operation interface 132 includes a design diagram 134 of a chip. For example, the design diagram 134 can display a chip 200 shown in FIG. 2. In some embodiments, the processor 120 can perform operations described below to adjust a configuration of the chip 200, and the memory 110 can store relevant data of the chip 200.

FIG. 2 is a schematic diagram of the chip 200 illustrated according to some embodiments of present disclosure. As shown in FIG. 2, the chip 200 includes multiple cells, such as the cells EA1-EA13, EB1-EB10, EC1-EC10 and EX1-EX5. In some embodiments, the cells in the chip 200 can be implemented by various standard logic cells, such as buffers, multiplexers, AND logic gates and OR logic gates.

In some embodiments, the operation interface 132 is configured to display the cells of the chip 200, and display corresponding peak current values on each cell of the chip 200. For example, the operation interface 132 displays a peak current value of the cell EA1 on the cell EA1. The operation interface 132 displays a peak current value of the cell EA2 on the cell EA2, and so on. The operation interface 132 displays a peak current value of the cell EA13 on the cell EA13. For clarity of FIG. 2, the specific peak current values are not shown in FIG. 2. In some embodiments, the peak current values can be various numbers.

In some embodiments, the processor 120 can perform dynamic power analysis to obtain the peak current values, and select a cell violating a power voltage drop condition according to a simulation result of the dynamic power analysis, to fix the chip 200. In some embodiments, the cell violating a power voltage drop condition is referred to as a victim.

In the embodiment shown in FIG. 2, the cell EA9 is a victim. Alternatively stated, the cell EA9 violates at least one power voltage drop condition. Correspondingly, around the cell EA9, the processor 120 identifies a zone PCZ1 surrounding the cell EA9. The zone PCZ1 surrounds the cell EA9 to cover a cell group EG1, in which the cell group EG1 includes the cell EA9 and cells EA1-EA8, EA10-EA13 surrounding the cell EA9. In some embodiments, the cell EA9 is located at a center of the zone PCZ1. Referring to FIG. 2 and FIG. 1, the operation interface 132 is further configured to display the zone PCZ1.

In some embodiments, the processor 120 is further configured to sum the peak current values of the cells EA1-EA13 to generate a summation current value ZPKC1 of the zone PCZ1. The operation interface 132 is further configured to display the summation current value ZPKC1 at the zone PCZ1.

As shown in FIG. 2, the zone PCZ1 has a width WD1 along a horizontal direction, and has a length LG1 along a vertical direction, in which the horizontal direction and the vertical direction are perpendicular to each other. In some embodiments, the length LG1 is approximately equal to three times of a length of the cell EA9 along the vertical direction. The width WD1 is approximately equal to a distance between two power rails transmitting the same reference power signal in the chip 200. However, the embodiments of present disclosure are not limited to this. In various embodiments, the zone PCZ1 can have various widths WD1 and various lengths LG1.

In some embodiments, in the cell group EG1, the processor 120 selects a cell having the largest peak current value according to the peak current values of the cell group EG1. For example, the processor 120 compares the peak current values of the cells EA1-EA13. In response to the peak current value of the cell EA10 being the largest one in the peak current values of the cells EA1-EA13, the processor 120 selects the cell EA10 for performing following operations.

In some embodiments, the processor 120 controls the display 130, such that the operation interface 132 displays, in the cell group EG1 covered by the zone PCZ1, the selected cell EA10 and the peak current value of the cell EA10.

Then, the processor 120 searches multiple accommodation spaces in the chip 200, according to a cell area of the cell EA10. In some embodiments, the cell area of the cell is equal to a length of the cell along the vertical direction multiplied by a width of the cell along the horizontal direction.

In some embodiments, the processor 120 can search the accommodation spaces in a concentric circle having a diameter of ten micrometers and using the cell EA9 as a center of the circle. However, the embodiments of present disclosure are not limited to this. In various embodiments, the processor 120 can search the accommodation spaces in various ranges.

Specifically, the processor 120 can search multiple spaces in the chip 200, and compare multiple space areas of the multiple spaces with a cell area of the cell EA10. When a space area of the multiple space areas is larger than the cell area of the cell EA10, a space in the spaces corresponding to the space area is assigned as one of the accommodation spaces.

For example, the processor 120 searches spaces SP1-SP3 in the chip 200. Along the horizontal direction, the space SP1 is located between the cells EB3 and EB7, the space SP2 is located between the cells EX2 and EX3, and the space SP3 is located between the cells EC3 and EC9. Along the vertical direction, the space SP1 is located between the cells EB5 and EX1, the space SP2 is located between the cells EA13 and EX4, and the space SP3 is located between the cells EC6 and EX5.

In response to a distance between the cells EB3 and EB7 being larger than or equal to a width of the cell EA10 and a distance between the cells EB5 and EX1 being larger than or equal to a length of the cell EA10, the processor 120 determines that a space area of the space SP1 is larger than or equal to the cell area of the cell EA10. Correspondingly, the processor 120 assigns the space SP1 as an accommodation space AS1.

Similarly, in response to a distance between the cells EC3 and EC9 being larger than or equal to the width of the cell EA10 and a distance between the cells EC6 and EX5 being larger than or equal to the length of the cell EA10, the processor 120 determines that a space area of the space SP3 is larger than or equal to the cell area of the cell EA10. Correspondingly, the processor 120 assigns the space SP3 as an accommodation space AS2.

On the other hand, in response to a distance between the cells EX2 and EX3 being smaller than the width of the cell EA10 or in response to a distance between the cells EA13 and EX4 being smaller than the length of the cell EA10, the processor 120 determines that a space area of the space SP2 is smaller than the cell area of the cell EA10. Correspondingly, the processor 120 determines that the space SP2 cannot accommodate the cell EA10.

In some embodiments, after the multiple accommodation spaces are assigned, the processor 120 is configured to identify multiple accommodation space zones, in which the multiple accommodation space zones surrounding the multiple accommodation spaces, respectively.

For example, after the accommodation spaces AS1 and AS2 are assigned, the processor 120 is configured to identify an accommodation space zone PCZ2 surrounding the accommodation space AS1 and an accommodation space zone PCZ3 surrounding the accommodation space AS2.

In some embodiments, the accommodation spaces AS1 and AS2 are located at centers of the accommodation space zones PCZ2 and PCZ3, respectively. In some embodiments, an area of each of the accommodation space zones PCZ2 and PCZ3 is equal to the area of the zone PCZ1. Alternatively stated, the accommodation space zones PCZ2, PCZ3 and the zone PCZ1 have the same size.

In some embodiments, the accommodation spaces AS1 and AS2 cover cell groups EG2 and EG3, respectively. In the embodiment shown in FIG. 2, the cell group EG2 includes cells EB1-EB10, and the cell group EG3 includes cells EC1-EC10. The cells EB1-EB10 and the cells EC1-EC10 have corresponding peak current values, respectively.

Then, the processor 120 sums the peak current values of the cells EB1-EB10, to generate a summation current value ZPKC2 of the accommodation space zone PCZ2. The processor 120 also sums the peak current values of the cells EC1-EC10, to generate a summation current value ZPKC3 of the accommodation space zone PCZ3.

Referring to FIG. 2 and FIG. 1, the operation interface 132 can display of the accommodation space zones PCZ2, PCZ3, the accommodation spaces AS1, AS2, the cell groups EG2, EG3 and the summation current values ZPKC2, ZPKC3. The operation interface 132 further can display the corresponding peak current values on the cells EB1-EB10 and the cells EC1-EC10, respectively. In which the area displayed by each of the accommodation spaces AS1 and AS2 is larger than the area displayed by the cell EA10.

Then, the processor 120 compares multiple summation current values, and moves the cell EA10 to the accommodation space in the accommodation space zone having the smallest summation current value.

For example, the processor 120 compares the summation current values ZPKC2 and ZPKC3. In response to the summation current value ZPKC2 being smaller than the summation current value ZPKC3, the processor 120 moves the cell EA10 into the accommodation space AS1.

In some embodiments, only when the summation current value of the accommodation space zone is smaller than the summation current value ZPKC1 of the zone PCZ1, the processor 120 determines whether to move the cell EA10 to the accommodation space zone. In the embodiment shown in FIG. 2, each of the summation current values ZPKC2 and ZPKC3 is smaller than the summation current value ZPKC1. Correspondingly, the processor 120 can determine whether to move the cell EA10 to the accommodation space zones PCZ2 or PCZ3.

In some embodiments, after the cell EA10 is moved, the processor 120 calculates the summation current value of the zone PCZ1 again. Alternatively stated, the processor 120 sums the peak current values of the cells EA1-EA9 and EA11-EA13, to generate a summation current value NZC1. In which the summation current value NZC1 is the summation current value ZPKC1 being updated. In the embodiment shown in FIG. 2, the summation current value NZC1 is equal to the summation current value ZPKC1 minus the peak current value of the cell EA10.

Furthermore, after the cell EA10 is moved, the processor 120 calculates the summation current value of the zone PCZ2 again. Alternatively stated, the processor 120 sums the peak current values of the cells EB1-EB10 and EA10, to generate a summation current value NZC2. In which the summation current value NZC2 is the summation current value ZPKC2 being updated. In the embodiment shown in FIG. 2, the summation current value NZC2 is equal to the summation current value ZPKC2 plus the peak current value of the cell EA10.

In some embodiments, the processor 120 compares the summation current value NZC1 with a predetermined summation current value. When the summation current value NZC1 is still larger predetermined summation current value, the processor 120 selects the cell having the largest peak current value in the remaining cells in the zone PCZ1, and moves the cell out from the zone PCZ1.

For example, when the summation current value NZC1 is larger than the predetermined summation current value, in response to the peak current value of the cell EA9 being larger than the peak current value of each of the cells EA1-EA8 and EA11-EA13, the processor 120 moves the cell EA9 from the zone PCZ1 to the accommodation space AS2 according to the summation current values.

In some embodiments, a manner of the processor 120 selecting the accommodation space for moving the cell EA9 is similar with the manner of the processor 120 selecting the accommodation space AS1 for moving the cell EA10 according to the summation current values ZPKC2 and ZPKC3. Therefore, some descriptions are not repeated.

In some embodiments, the processor 120 is configured to generate the predetermined summation current value according to the summation current value ZPKC1 before updated. For example, before the cell EA10 is moved, the processor 120 calculates the summation current value ZPKC1 of the zone PCZ1, and multiplies the summation current value ZPKC1 with a ratio to generate the predetermined summation current value. Alternatively stated, the predetermined summation current value can be equal to the summation current value ZPKC1 multiplied by the ratio. In some embodiments, the ratio can be equal to 70%. However, the embodiments of present disclosure are not limited to this.

Referring to FIG. 2 and FIG. 1, after the cell EA10 is moved, the processor 120 updates the summation current value ZPKC1 displayed at the zone PCZ1, such that the operation interface 132 displays the updated summation current value NZC1 in the zone PCZ1.

Furthermore, after the cell EA10 is moved, the processor 120 updates the summation current value ZPKC2 displayed at the zone PCZ2, such that the operation interface 132 displays the updated summation current value NZC2 in the zone PCZ2.

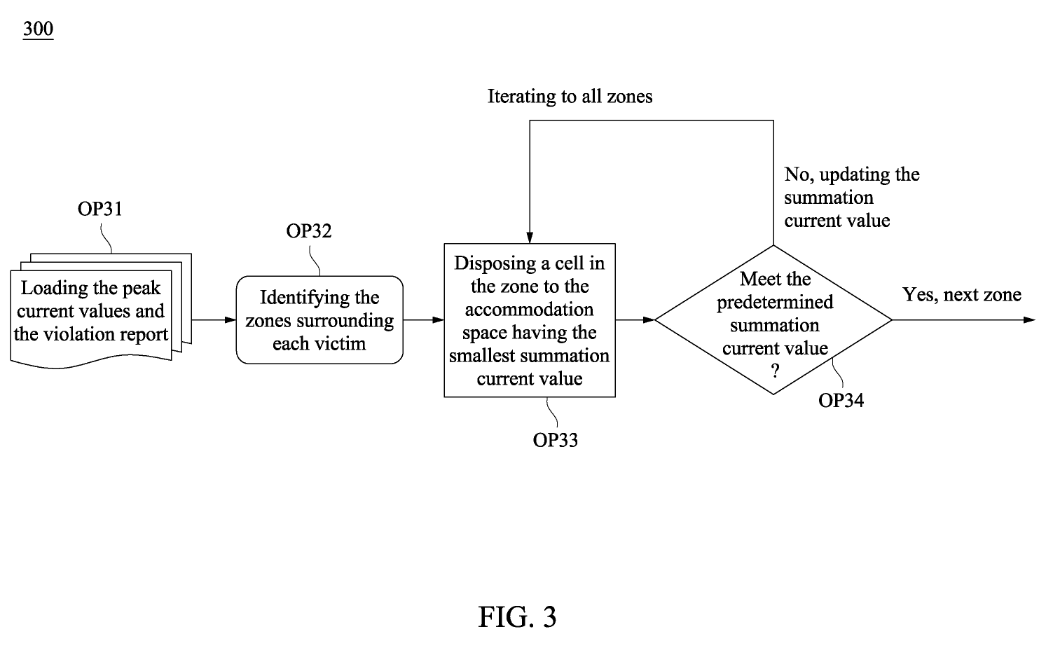

FIG. 3 is a schematic diagram of a chip designing method 300 illustrated according to some embodiments of present disclosure. As shown in FIG. 3, the chip designing method 300 includes operations OP31-OP34. Referring to FIG. 1 to FIG. 3, the chip designing method 300 can be applied to the processing device 100 and the chip 200. The following descriptions use the processing device 100 and the chip 200 as example. However, the embodiments of present disclosure are not limited to this. In various embodiments, the chip designing method 300 can be applied to various processing devices and various chips.

During the operation OP31, the peak current values and the violation report are loaded. For example, the processor 120 loads the peak current values of the cells of the chip 200 and the violation report of the victims.

During the operation OP32, the zones surrounding each victim are identified. For example, the processor 120 identifies the zone PCZ1 surrounding the victim EA9, and identifies the zones surrounding other victims.

During the operation OP33, a cell in the zone is disposed to the accommodation space having the smallest summation current value. For example, the processor 120 disposes the cell EA10 in the zone PCZ1 to the accommodation space AS1 having the smallest summation current value ZPKC2.

During the operation OP34, it is determined that whether the predetermined summation current value is meet. For example, the processor 120 determines that whether the summation current value NZC1 is smaller than the predetermined summation current value. When the summation current value NZC1 is smaller than the predetermined summation current value, the processor 120 moves a cell in a next zone having a victim. When the summation current value NZC1 is smaller than the predetermined summation current value and there are no other victims in the chip 200, the work process of present invention is ended, and the corresponding chip 200 can be manufactured. As a result, a quantity of victims in the chip 200 is reduced.

When the summation current value NZC1 is larger than the predetermined summation current value, the processor 120 updates the summation current value. For example, the processor 120 updates the summation current values ZPKC1 and ZPKC2 as the summation current values NZC1 and NZC2, respectively. Then, the processor 120 performs the operation OP33 again, to move the next cell out from the zone PCZ1.

In some embodiments, the operations OP33 and OP34 are iterated to all zones of the victims, such that all zones of the victims meet the predetermined summation current value.

In some approaches, when repairing cells with excessive power voltage drop, the cell is moved to the power voltage drop cold spot to resolve the issue of excessive concentration that violates the voltage drop condition. The drawback of this method is that the cells violating the drop condition may not necessarily be the main aggressor of the excessive power voltage drop. If cells are moved blindly, it may not only fail to guarantee a fix but also provide no insight into how many cells need to be moved to address the corresponding power voltage drop hotspot. Additionally, moving too many cells may delay the design tape-out schedule.

Compared to above approaches, in embodiments of present disclosure, the processor selects the cell EA10 being move out from the zone PCZ1 according to the peak current values of the cells, and determines the accommodation space AS1 for moving in the cell EA10 according to the summation current values corresponding to the accommodation space zones. As a result, the current density can be effectively decreased and the cells violating the voltage drop condition can be reduced. Furthermore, the design tape-out schedule can be expedited.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A chip designing method, comprising:
identifying a zone surrounding a first cell;
in a cell group covered by the zone, selecting a second cell according to peak current values of the cell group;
searching accommodation spaces according to a cell area of the second cell;
identifying accommodation space zones, the accommodation space zones surrounding the accommodation spaces, respectively; and
moving the second cell to a first accommodation space in the accommodation space zones according to first summation current values of the accommodation space zones.

2. The chip designing method of claim 1, further comprising:
after moving the second cell, comparing a second summation current value of the zone with a predetermined current value;
when the second summation current value is larger than the predetermined current value, selecting a third cell in the cell group according to the peak current values; and
moving the third cell to a second accommodation space in the accommodation space zones according to the first summation current values.

3. The chip designing method of claim 2, further comprising:
before moving the second cell, computing a third summation current value of the zone,
wherein the predetermined current value is equal to the third summation current value multiplied by a ratio.

4. The chip designing method of claim 1, wherein the first cell violates at least one power voltage drop condition.

5. The chip designing method of claim 1, wherein selecting the second cell comprises:
comparing the peak current values,
wherein the second cell has the largest one of the peak current values.

6. The chip designing method of claim 1, wherein searching the accommodation spaces comprises:
comparing space areas of spaces with the cell area of the second cell; and
when a space area of the space areas is larger than the cell area, assigning a space in the spaces corresponding to the space area as one of the accommodation spaces.

7. The chip designing method of claim 1, wherein moving the second cell to the first accommodation space according to the first summation current values comprises:
comparing the first summation current values,
wherein the first accommodation space has the smallest one of the first summation current values.

8. The chip designing method of claim 1, wherein an area of each of the accommodation space zones is equal to an area of the zone.

9. A processing device of performing a chip designing method, comprising:
a memory configured to store relevant data of a chip;
a processor configured to perform following operations:
identifying a zone surrounding a first cell;
in a cell group covered by the zone, selecting a second cell according to peak current values of the cell group;
searching accommodation spaces according to a cell area of the second cell;
identifying accommodation space zones, the accommodation space zones surrounding the accommodation spaces, respectively; and
moving the second cell to a first accommodation space in the accommodation space zones according to first summation current values of the accommodation space zones; and
a display configured to display the peak current values and the accommodation space zones.

10. The processing device of claim 9, wherein the processor is further configured to perform following operations:
after moving the second cell, comparing a second summation current value of the zone with a predetermined current value;
when the second summation current value is larger than the predetermined current value, selecting a third cell in the cell group according to the peak current values; and
moving the third cell to a second accommodation space in the accommodation space zones according to the first summation current values.

11. The processing device of claim 10, wherein the processor is further configured to perform following operations:
before moving the second cell, computing a third summation current value of the zone,
wherein the predetermined current value is equal to the third summation current value multiplied by a ratio.

12. The processing device of claim 9, wherein the second cell has the largest one of the peak current values.

13. The processing device of claim 9, wherein the processor is further configured to perform following operations:
comparing space areas of spaces with the cell area of the second cell; and
when a space area of the space areas is larger than the cell area, assigning a space in the spaces corresponding to the space area as one of the accommodation spaces.

14. The processing device of claim 9, wherein the first accommodation space has the smallest one of the first summation current values.

15. An operation interface of chip design, comprising a design diagram of a chip, the design diagram is displayed by a display and controlled by a processor, wherein the processor is configured to perform following operations:
displaying a zone surrounding a first cell of the chip and a first summation current value of the zone;
in a cell group covered by the zone, displaying a second cell being selected and a peak current value of the second cell;
displaying accommodation spaces, accommodation space zones respectively surrounding the accommodation spaces and second summation current values of the accommodation space zones, wherein the second summation current values of the accommodation space zones are smaller than the first summation current value of the zone; and
moving the second cell to a first accommodation space in the accommodation space zones.

16. The operation interface of claim 15, wherein the processor is further configured to perform following operations:
in the cell group, displaying peak current values of each cell of the cell group,
the peak current value of the second cell is a largest one of the peak current values of each cell of the cell group.

17. The operation interface of claim 15, wherein an area displayed by each accommodation space of the accommodation spaces is larger than or equal to an area of displayed by the second cell.

18. The operation interface of claim 15, wherein the processor is further configured to perform following operations:
after moving the second cell, updating the first summation current value displayed in the zone.

19. The operation interface of claim 18, wherein the processor is further configured to perform following operations:
after moving the second cell, updating a third summation current value displayed in an accommodation space zone corresponding to the first accommodation space.

20. The operation interface of claim 15, wherein the accommodation space zones have the same size.
